(19) United States
(12) Patent Application Publication
(10) Pub. No.: US 2013/0304900 A1
(43) Pub. Date: Nov. 14, 2013

(54) REPUTATION MANAGEMENT USING EVOLVING REPUTATION SCORES

(71) Applicants: Slim Trabelsi, Nice (FR); Michele Bezzi, Le Haut Sartoux-Valbonne (FR); Gilles Montagnon, Mougins (FR)

(72) Inventors: Slim Trabelsi, Nice (FR); Michele Bezzi, Le Haut Sartoux-Valbonne (FR); Gilles Montagnon, Mougins (FR)

(73) Assignee: SAP AG, Walldorf (DE)

(21) Appl. No.: 13/471,078

(22) Filed: May 14, 2012

(51) Int. Cl. G06F 15/173

(52) U.S. Cl. 709/224

(57) ABSTRACT

An evidence monitor may monitor interactions between at least one service provider and at least one service consumer during a time period. The evidence monitor may receive negative feedback from the at least one service consumer regarding a corresponding interaction of the interactions. A reputation engine may increase a reputation score of the at least one service provider during the time period in accordance with a growth rate, as the interactions occur during the time period. The reputation engine may also decrease the reputation score of the at least one service provider in response to the negative feedback and in accordance with a negative feedback response characteristic.

### TECHNICAL FIELD

This description relates to reputation management.

### BACKGROUND

Computer networks enable remote transactions between providers and consumers, in which the consumers may have little or no direct knowledge of the providers, and/or goods/services offered by the providers. Nonetheless, such interactions often require a consumer to provide a payment or otherwise assume risk, prior to receipt of one or more corresponding goods and/or services.

In order to mitigate such risks, various trust and/or reputation systems have been developed, with the intent of lowering risks assumed by the consumers by providing the consumers with information related to previous transactions consummated by specific providers. In specific examples, consumers may be provided with an opportunity to provide positive or negative feedback regarding a current or previous interaction with a specific provider, so that future potential consumers may utilize such feedback in assessing a trustworthiness of the specific provider.

In practice, however, such feedback systems may require a relatively large number of proactive feedback responses, which may negatively impact a scalability of such systems, and which may result in inaccurate results when consumers choose not to provide feedback. In the latter regard, it may occur that consumers are more likely to provide positive feedback than negative feedback. For example, consumers who have a negative experience with a service provider may be hesitant to submit negative feedback, for fear of reprisals, to avoid feeling discourteous, or for other reasons. Consequently, reputations of service providers may be skewed in the direction of overly-high reputation scores.

Further, in many cases, some or all of the consumers interacting with a particular service provider may be automated software agents or services. In such cases, such consumers may be unable to provide feedback to existing, conventional feedback systems. Consequently, interactions with such software consumers may not be reflected in reputation scores of corresponding service providers.

Thus, conventional feedback systems may be prone to providing inaccurate and/or incomplete reputation scores for corresponding service providers. Moreover, even to the extent that such conventional feedback systems provide reputation scores for service providers, the conventional feedback systems may fail to do so in a manner that is scalable, efficient, accurate, and convenient.

### SUMMARY

According to one general aspect, a system may include instructions recorded on a non-transitory computer readable storage medium and executable by at least one processor. The system may include an evidence monitor configured to cause the at least one processor to monitor interactions between at least one service provider and at least one service consumer during a time period, and further configured to cause the at least one processor to receive negative feedback from the at least one service consumer regarding a corresponding interaction of the interactions. The system also may include a reputation engine configured to cause the at least one processor to increase a reputation score of the at least one service provider during the time period in accordance with a growth rate, as the interactions occur during the time period, and further configured to cause the at least one processor to decrease the reputation score of the at least one service provider in response to the negative feedback and in accordance with a negative feedback response characteristic.

According to another general aspect, a computer-implemented method may cause at least one processor to execute instructions recorded on a computer-readable storage medium. The method may include monitoring interactions between at least one service provider and at least one service consumer during a time period, and increasing a reputation score of the at least one service provider during the time period in accordance with a growth rate, as the interactions occur during the time period. The method may include receiving negative feedback from the at least one service consumer regarding a corresponding interaction of the interactions, and decreasing the reputation score of the at least one service provider in response to the negative feedback and in accordance with a negative feedback response characteristic.

According to another general aspect, a computer program product may be tangibly embodied on a non-transitory computer-readable medium and may include instructions that, when executed, are configured to cause at least one processor to monitor interactions between at least one service provider and at least one service consumer during a time period, increase a reputation score of the at least one service provider during the time period in accordance with a growth rate, as the interactions occur during the time period, receive negative feedback from the at least one service consumer regarding a corresponding interaction of the interactions, and decrease the reputation score of the at least one service provider in response to the negative feedback and in accordance with a negative feedback response characteristic.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a reputation management system.

FIG. 2 is a flowchart illustrating example operations of the reputation management system of FIG. 1.

FIG. 3 is a block diagram of an example embodiment of the reputation management system of FIG. 1, implemented in a service broker architecture.

FIG. 4 is a flowchart illustrating more detailed example operations of the reputation management system of FIGS. 1 and 4.

FIGS. 5A-5D are graphs illustrating example temporal evolutions of reputation scores calculated using the reputation management system of FIGS. 1-4.

### DETAILED DESCRIPTION

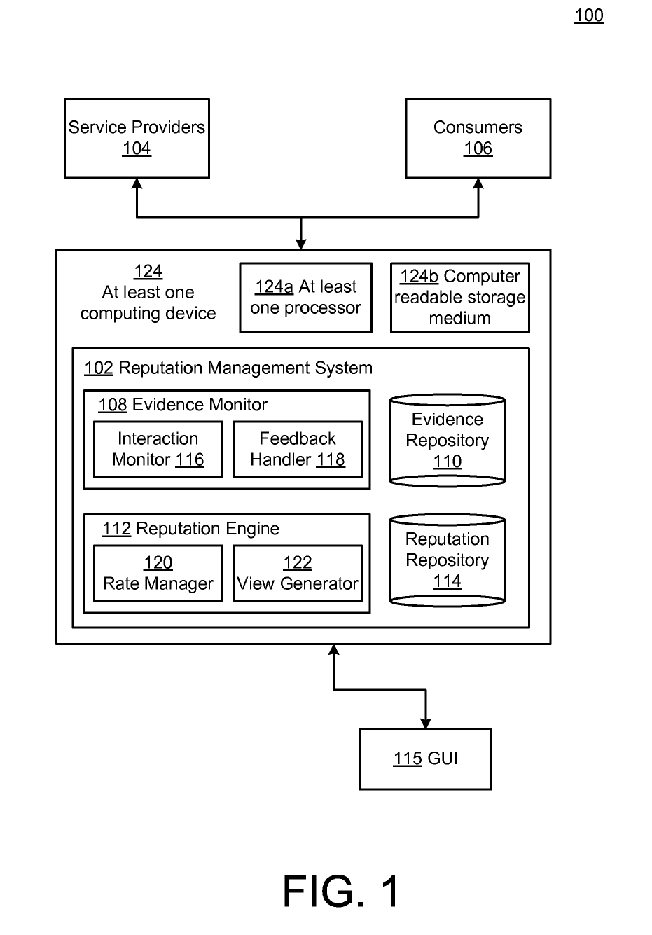

FIG. 1 is a block diagram of a reputation management system 102. As described in detail below, the reputation management system 102 may be configured to manage a reputation score of a service provider 104, based on interactions between the service provider 104 and a plurality of consumers 106, and in conjunction with feedback received from the consumers 106 (and/or from other sources). More specifically, the reputation management system 102 may calculate a temporal evolution of the reputation score of the service provider 104, so that a reputation score of the service provider 104 provided at any given point in time represents a value of the reputation score in the context of the temporal evolution thereof, and at the relevant point in time. By providing a reputation score in this manner, and in accordance with the various example techniques described herein, the reputation management system 102 may be configured to provide an accurate, useful reputation score, with minimal reliance on the direct participation of the consumers 106, and in a manner that is scalable and that minimizes required computational resources.

In example embodiments, the service provider 104 may represent virtually any seller of goods and/or services which may be purchased by the various consumers 106. Such sales may occur online, using a computer network, e.g., the public Internet. For example, the service provider 104 may provide a website, and the consumers 106 may visit the website to purchase goods or services sold by the service provider 104. In other example embodiments, however, the service provider 104 may conduct such sales as traditional, physical, point-of-sale transactions, as long as the reputation management system 102 is provided with relevant information regarding such transactions, as described in detail herein.

Further, although the interactions between the service provider 104 and the consumers 106 are primarily described herein in the context of financial transactions, e.g., sales of goods and/or services, it will be appreciated that such examples are non-limiting, and that the interactions may be represent virtually any type of interaction in which the consumers 106 may wish to assess a trustworthiness of the service provider 104.

For example, in the context of online forums provided for information exchange, it may be desirable for participants to assess a trustworthiness of information provided by other participants. By way of more specific examples, in the context of discussion boards, chat rooms, and other online forums, participants may provide information in a more or less anonymous fashion, so that it is difficult for other participants to assess a trustworthiness of the anonymously-provided information. In such contexts, each participant may be considered to represent an example of the service provider 104, so that the interactions with the various consumers 106 may be understood to represent information exchanges between the providing participant and any consuming participant who may receive the information.

Thus, in the above examples, and in various other examples which are not specifically or explicitly described herein, the service provider 104 may be understood to represent a human or human-operated system, and/or an autonomous software agent or other software construct. Of course, although only a single service provider is illustrated in the example of FIG. 1, it will be appreciated that the reputation management system 102 may simultaneously provide related reputation management services for a large number of such service providers. Similarly, it may thus be appreciated that the various consumers 106 may represent virtually any number of human or software entities capable of conducting relevant types of interactions with corresponding service providers.

In the example of FIG. 1, the reputation management system 102 is configured to monitor the various interactions between the service provider 104 and the consumers 106, and to automatically increase or enhance a reputation score of the service provider 104 over time, unless and until any negative feedback regarding the service provider 104 is received from the consumers 106 and/or from other sources. Thus, although positive feedback regarding the service provider 104 may optionally be considered or included as part of the calculation of a reputation score of the service provider 104, it may be appreciated that the reputation management system 102 does not rely on, or require, such positive feedback in order to provide an accurate, useful, and timely reputation score for the service provider 104. Consequently, as described in detail herein, the reputation management system 102 requires minimal computational resources to calculate the reputation score of the service provider 104, and may simultaneously calculate such reputation scores for a relatively large number of service providers.

In this regard, in the example of FIG. 1, the reputation management system 102 may include an evidence monitor 108 which is configured to collect information regarding the interactions between the service provider 104 and the various consumers 106. For example, as described in more detail below, the evidence monitor 108 may be configured to collect information characterizing a nature, type, extent, or timing of individual interactions between the service provider 104 and the consumers 106, as well as other relevant information (e.g., negative feedback from a particular consumer regarding a particular transaction). All such evidence collected by the evidence monitor 108 may be stored in a desired fashion, and to a desired extent, using an evidence repository 110.

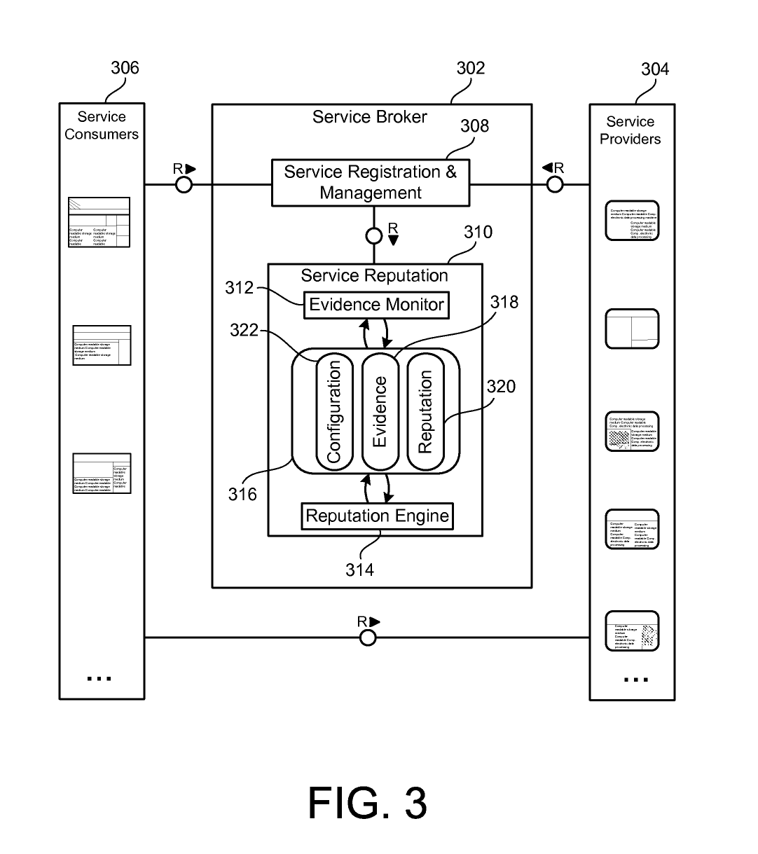

Various techniques may be utilized by the evidence monitor 108 to populate the evidence repository 110. For example, the service provider 104 may be configured to provide relevant information regarding the various interactions to the evidence monitor 108 directly. In this regard, it may be appreciated that the service provider 104 (or an administrator thereof) may itself be responsible for installing, configuring, maintaining, and otherwise utilizing the reputation management system 102, in which case the service provider 104 may be operable to collect interaction-related data for direct providing thereof to evidence monitor 108. In other example implementations, as described in more detail below with respect to FIG. 3, the reputation management system 102 may be operated by a third party provider, so that the service provider 104 may be required to transmit relevant information thereto.

In specific examples, the service provider 104 may install software agents which are configured to collect and transmit such data. In still other example implementations, an intermediate publish/subscribe system (not explicitly illustrated in the example of FIG. 1) may be configured to collect transactions or other interaction-related information from a plurality of service providers, including the service provider 104. Then, the evidence monitor 108 may be configured to subscribe to the publish/subscribe system, so that relevant interaction-related information associated with the specific service provider 104 will automatically be provided to the evidence monitor 108. Many other techniques for determination of interaction-related data by the evidence monitor 108 may be implemented, and may be dependent upon, e.g., a context or other setting of the service provider 104, the consumers 106, or the nature of the interactions there between, as would be apparent to one of skill in the art.

Then, a reputation engine 112 may be configured to access, over a period of time, the evidence repository 110 with respect to the service provider 104, and to utilize extracted information to calculate a continuous and evolving reputation score for the service provider 104, based thereon. For example, in the example of FIG. 1, it may be assumed that the various interactions between the service provider 104 and the consumers 106 occur during a particular time period. As such, the interactions may occur in various patterns, e.g., relatively frequently and/or steadily within the relevant time period, or in a sporadic or unpredictable fashion during the time period. In these and various other related contexts, the evidence monitor 108 may collect the various interaction-related information continuously and in real time (or with any acceptable or desired delay, such as when the reputation management system 102 may desire to minimize network transmission resources by transmitting sets of interaction-related information, collected during a portion of the time period, and transmitted together).

In this way, the reputation engine 112 may also, continuously and in real time (or, again, with an acceptable or desirable delay), calculate an evolving reputation score for the service provider 104. A manner in which the reputation engine 112 may evolve the reputation score of the service provider 104 over time may vary considerably, based on particular configurations of the reputation engine 112, some of which are described in detail below by way of example.

Nonetheless, it may generally be appreciated that the reputation engine 112 may utilize a reputation repository 114 to obtain specific characteristics, parameters, and configurations to be utilized in processing interaction-related data from the evidence repository 110 to obtain the continuous, evolving reputation score for the service provider 104. Again, more detailed and specific examples are provided below, but in general it may be appreciated that the reputation repository 114 may include, e.g., one or more rates of increase of the reputation score as a function of time and/or number of interactions, weight information characterizing a type and extent of impact of receipt of negative feedback regarding the service provider 104 rationalization values, and various other types of information which may be useful to the reputation engine 112 in calculating the continuous, evolving reputation score of the service provider 104.

The reputation repository 114 also may be utilized to store calculated reputation scores provided by the reputation engine 112. For example, the reputation repository 114 may store designated quantities of historical data characterizing the evolution of the reputation score of the service provider 104 over one or more time periods, potentially in conjunction with relevant information which may assist present and future consumers in interpreting the reputation scores.

For example, it may occur that the service provider 104 releases a first version of a product for sale, and that during a time period during which the first version is sold, the evolving reputation score of the service provider may generally move higher. The service provider 104 may then release the second version of the product, which may suffer from a design flaw or other defect, so that the reputation score of the service provider 104 may decline substantially during a time period during which the second version is available. Finally, the service provider 104 may release a third version of the product which corrects the defect of the second version, so that again the reputation score of the service provider 104 may trend higher during a current time period in which the third version is available. Consequently, upon providing the continuous, evolving reputation score to a present or future consumer, the present or future consumer may be enabled to interpret that negative aspects of the reputation score of the service provider 104 were associated with the second version, and thereby may determine that such negative feedback is not relevant to the consumer's decision as to whether to purchase the third version of the product.

Further in the example of FIG. 1, a graphical user interface (GUI) 115 is illustrated, which conceptually and generically represents one or more user interfaces which may be utilized by the various entities which might interact with the reputation management system 102. For example, the GUI 115 may represent a GUI utilized by an administrator of the reputation management system 102, e.g., in scenarios in which a third party provider provides the reputation management system 102 for the use of the service provider 104. Of course, similarly, the GUI 115 may represent an interface utilized by the service provider 104, in scenarios where the service provider 104 provides the reputation management system 102 directly.

In these and related examples, the GUI 115 may be utilized to enter or modify various configuration information governing various operations of the reputation management system 102. For example, with regard to the evidence monitor 108, the GUI 115 may be utilized to parameterize evidence collection operations. For example, the GUI 115 may be utilized to set or configure transmission techniques used by the evidence monitor 108 to interact with the service provider 104. In other examples, the GUI 115 may be utilized to configure the type of evidence collected, and/or a frequency with which the evidence is collected, and/or may be used to set one or more filters which remove undesired portions (with respect to the service provider 104) of the collected evidence.

Similarly, with respect to the reputation engine 112, the GUI 115 may be utilized to parameterize operations thereof. For example, the GUI 115 may be utilized to enter growth rates or other parameters governing a manner in which the reputation score of the service provider 104 evolves over time in response to existing evidence in the evidence repository 110. Further, the GUI 115 may be utilized to configure operations of the reputation engine 112 with respect to a quantity of historical reputation data stored in the reputation repository 114 (and, by implication, a corresponding amount of the evidence stored in the evidence repository 110).

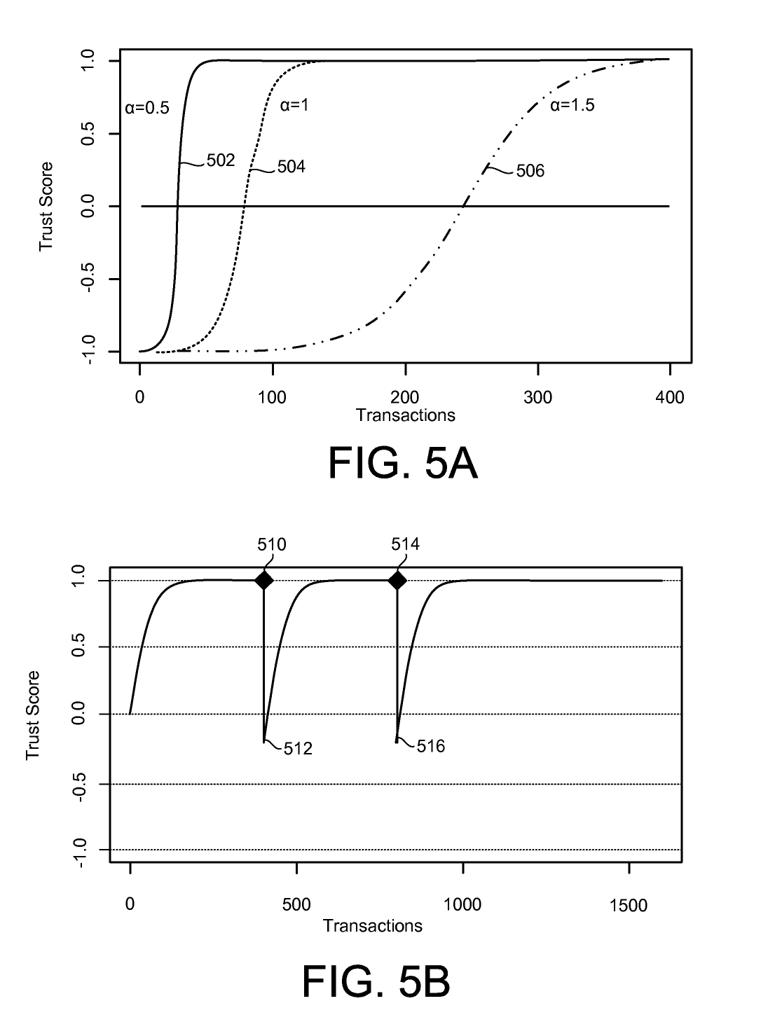

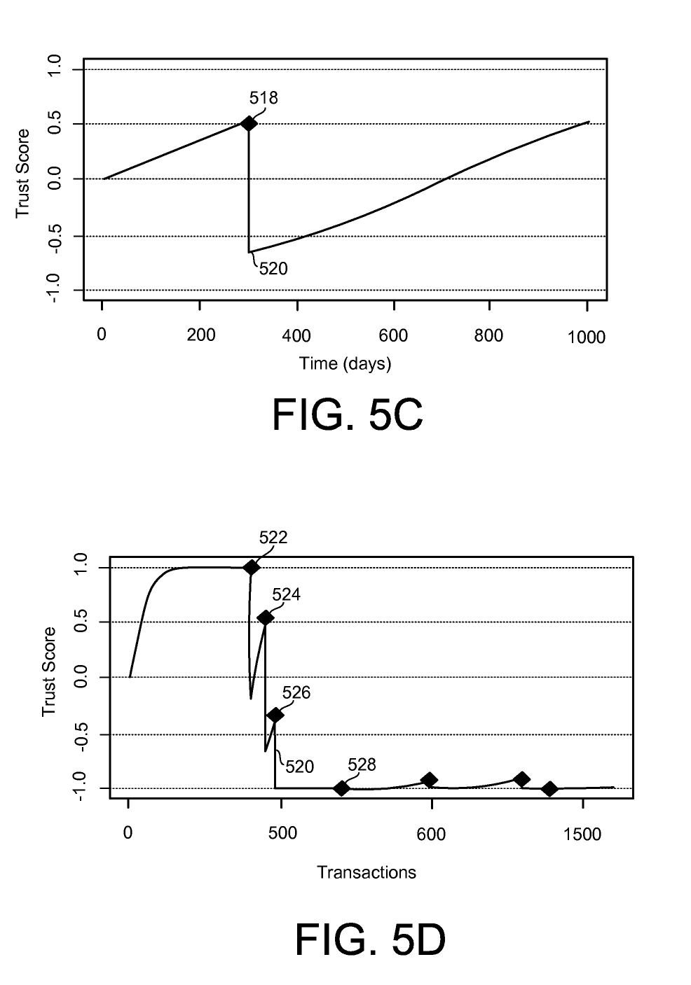

In a final example, the GUI 115 may be utilized to configure the manners in which the reputation engine 112 displays or otherwise provides reputation scores. For example, as in the examples just described, and as illustrated in more detail below with respect to the examples of FIGS. 5A-5D, the reputation engine 112 may display the continuous reputation score over a relevant time period. Further, as also referenced above, the GUI 115 may be utilized to configure the reputation engine 112 to include supplemental reputation data which may be useful to consumers in interpreting the reputation score (e.g., the version-related information described above).

As may be appreciated from the preceding examples, the GUI 115 also may represent an interface utilized by the consumers 106 in reviewing reputation scores of the service provider 104. Thus, the GUI 115 may be utilized to display the reputation score over a relevant period of time or a number of interactions. The GUI 115 in this context also may be utilized by the consumers 106 to configure various manners in which the consumers 106 may wish to view the reputation score in this context. For example, the consumers 106 may be enabled to personalize the amount of time over which the reputation score is provided, or, similarly, may specify a number of interactions over which the reputation score is provided. Similarly, each consumer 106 may be enabled to specify whether and to what extent any available supplemental reputation data is displayed or included within a provided reputation score.

Additional examples of features, functions, and operations of the GUI 115 are provided in detail below, or would be apparent to one of skill in the art. However, it may be appreciated that although the GUI 115 is illustrated as a separate, stand-alone component in the example of FIG. 1, in additional or alternative implementations, the GUI 115 may be incorporated in whole or in part into various existing interfaces associated with the service provider 104 and/or the consumers 106. For example, in scenarios in which the service provider 104 sells products online, the service provider 104 may wish to provide a reputation of a specific product in conjunction with information regarding the product itself. In such scenarios, the GUI 115 experienced by the consumers 106 may be incorporated into relevant portions of one or more webpages describing the associated product for sale.

In further detail regarding the operations of the reputation management system 102, the evidence monitor 108 is illustrated as including an interaction monitor 116 and a feedback handler 118. The interaction monitor 116 may be configured to receive or otherwise determine any necessary parameters related to, or characteristics of, the interaction between the service provider 104 and the consumers 106. As referenced herein, such monitoring may include direct or indirect participation on the part of the service provider 104 and/or the consumers 106, or may include intercepting information regarding interactions, without participation of the service provider 104 and/or the consumers 106. As also referenced, the GUI 115 may be utilized to configure operations of the interaction monitor 116, and thereby govern a manner in which interaction-related data is collected by the interaction monitor 116.

Analogously, the feedback handler 118 may be configured to receive any negative feedback provided by the consumers 106. In so doing, the feedback handler 118 may correlate the received negative feedback with a relevant service provider and/or product or service. Again, the GUI 115 may be utilized to parameterize operations of the feedback handler 118. For example, the feedback handler 118 may be configured to accept various types or degrees of negative feedback. In addition, as referenced above, the feedback handler 118 may optionally be configured to receive positive feedback, e.g., to use as supplemental reputation data during a later providing of the evolving reputation score.

As with the evidence monitor 108, the reputation engine 112 also may include various subcomponents. For example, the reputation engine 112 may include a rate manager 120, which may be configured to receive, maintain, and implement one or more growth rates characterizing changes to a corresponding reputation score, e.g., over time and/or in response to specific events.

For example, as described in more detail herein, a reputation score of the service provider 104 may initially be set at an initialization value, and thereafter, in the absence of negative feedback or other relevant events, may grow over time and/or in response to numbers or types of interactions with the various consumers 106, until some maximum reputation score is reached or approached. A corresponding growth rate of the rate manager 120 may characterize a nature of such growth of the reputation score of the service provider in such context. For example, the rate manager 120 may dictate that the reputation score increases quickly and thereafter approaches a maximum value relatively slowly, or, in alternative implementations, may dictate that the reputation score initially increases slowly, but then later approaches the maximum score more rapidly.

Thus, it may be appreciated that a large number of possibilities may be implemented with regard to the growth rate characterizing the reputation score of the service provider 104. Thus, for example, the GUI 115 may be utilized by an administrator or other user of the reputation management system 102 to input a desired growth rate and/or related characteristics describing a desired manner of evolution of the reputation score of the service provider 104 over time. In other example embodiments, however, the rate manager 120 may simply receive or otherwise determine relevant information regarding the service provider 104, the consumers 106, and/or the various interactions there between, and may select, calculate, or otherwise determine an appropriate growth rate based thereon. Additional examples for obtaining and implementing one or more such growth rates are described in more detail below, or would be apparent to one of skill in the art, based on the present description.

As referenced above, and described in more detail below, receipt of negative feedback regarding the service provider 104 and/or one or more relevant interactions from the consumers 106 may result in a decrease in the reputation score of the service provider 104. In various implementations, it may thus be appreciated that receipt of a single instance of negative feedback may have varying levels of impact on the reputation score of the service provider 104. Additionally, or alternatively, receipt of multiple instances of negative feedback, perhaps within a defined time window, also may have varying levels of impact on the reputation score of the service provider 104.

Thus, the rate manager 120 also may be configured to receive, determine, and/or implement such effects of one or more instances of negative feedback with respect to the reputation score of the service provider 104. As described above with respect to the growth rate of the reputations score, the nature and extent of impact of instances of negative feedback may be characterized by an administrator or other user of the reputation management system 102, using the GUI 115, and thereafter may be received and stored using the rate manager 120. In additional or alternative examples, the rate manager 120 may itself calculate, determine, or derive a nature and/or extent of an impact of negative feedback, based on, e.g., characteristics of the service provider 104, the consumers 106, interactions there between, and/or a corresponding growth rate governing an overall growth characteristic of the reputation score of the service provider 104.

In some example embodiments, after receipt of one or more instances of negative feedback, the reputation score of the service provider 104 may resume growth according to the previously-described growth rate. However, in additional or alternative embodiments, the rate manager 120 also may be configured to resume growth according to a different growth rate, referred to herein as a redemption rate. In other words, for example, the reputation score of the service provider 104 may continue to grow over time and/or in response to new interactions with the consumers 106, but, after receipt of the negative feedback, may do so at a different rate and/or in a different way than before the negative feedback was received. More detailed examples of a nature and implementation of one or more such redemption rates with respect to the reputation score of the service provider 104 are provided below, but, in general, as with the original growth rate and the negative feedback characteristics, it may be appreciated that the rate manager 120 may receive characteristics of the redemption rate by way of the GUI 115, and/or may automatically determine characteristics of the redemption rate, as desired or configured by an administrator or other user of the reputation management system 102.

Meanwhile, the view generator 122 may be configured to calculate, determine, and provide any of the several views described above. For example, the view generator 122 may provide various configuration views, via the GUI 115, by which an administrator or user may set parameters related to, e.g., growth rates, handling of negative feedback, and variations on how the evolving reputation score is displayed. Further, the view generator 122 may be understood to display the reputation score of the service provider 104, perhaps in conjunction with any other desired supplemental reputation information.

For example, as illustrated and described in more detail below with respect to FIGS. 5A-5D, the view generator 122 may utilize the GUI 115 to display a growth of a reputation score over time, including any decreases experienced as a result of receiving negative feedback within the relevant time period. Although not explicitly illustrated in the examples of FIGS. 5A-5D, but as may be understood from the above description, the view generator 122 also may be configured to provide various types and quantities of supplemental reputation information. For example, the view generator 122 may display text received from one of the consumers 106 in conjunction with positive and/or negative feedback that may have been received at a particular time within the relevant time period. In such cases, the view generator 122 may display such supplemental reputation information as being explicitly associated with a specific point in time, e.g., and which the feedback was received.

Finally in the example of FIG. 1, the reputation management system 102 is illustrated as executing in the context of at least one computing device 124, which includes at least one processor 124a and computer readable storage medium 124b (of course, the at least one computing device may be understood to include various other integral and/or peripheral components, including, e.g., components providing power, communications, and input/output functionalities). Thus, for example, instructions required to execute the reputation management system 102 may be stored using the computer readable storage medium 124b, and may be executed by the at least one processor 124a to thereby provide the various features and functions described herein. Of course, the computer readable storage medium 124b also may represent or include various other types of computer memory, such as, e.g., memory used to provide the evidence repository 110 and/or the reputation repository 114.

As the at least one computing device 124 may be understood to represent two or more computing devices, the reputation management system 102 may be executed in the context of a distributed system. For example, portions of the reputation management system 102 may be executed at the service provider 104, while other portions thereof may be executed in the context of a third party provider. Somewhat similarly, the at least one processor 124a may be understood to represent two or more processors, so that, for example, operations of the reputation management system 102 may be understood to execute in parallel, for increased speed and efficiency thereof.

In the example of FIG. 1, the reputation management system 102 is illustrated as including the various modules and components described above. Of course, it may be appreciated that such illustration and explanation are merely for the sake of example, and that many additional or alternative components may be used. Moreover, it may be appreciated that features and functions of any one component may be obtained using two or more subcomponents, e.g., in the distributed computing example described above. Conversely, in various implementations, any two or more of the components may be combined for execution of associated features and functions using a single component.

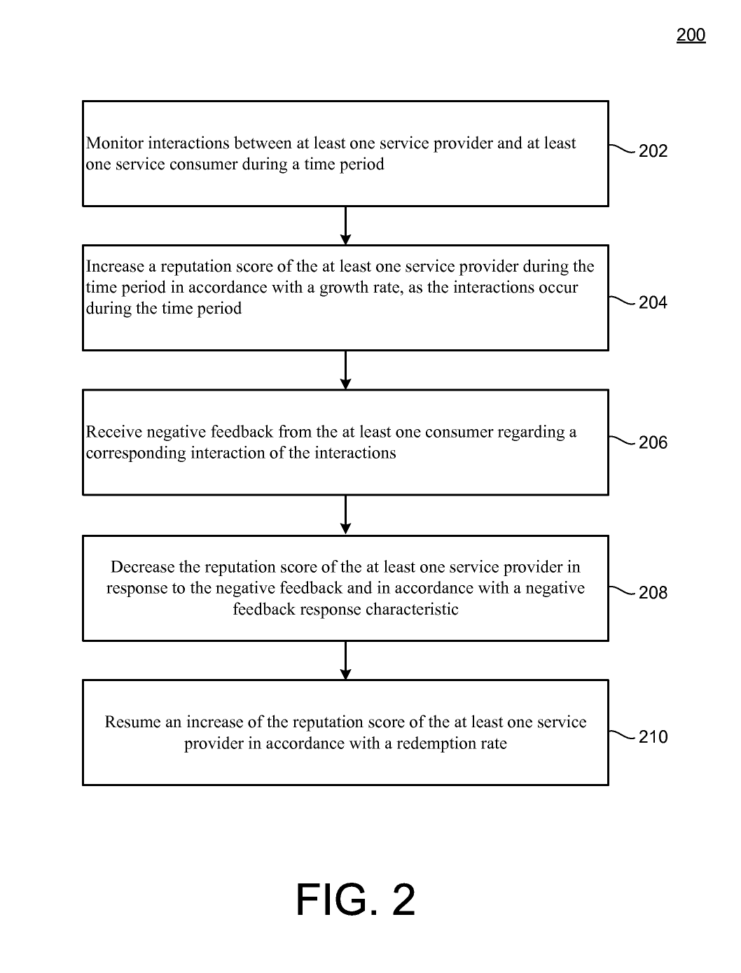

FIG. 2 is a flowchart illustrating example operations of the reputation management system 102 of FIG. 1. In the example of FIG. 2, operations 202-210 are illustrated as separate, sequential operations. However, it may be appreciated that any two or more of the operations 202-210 may execute in a partially or completely overlapping or parallel manner, and/or may execute in a nested, iterative, or looped fashion. Moreover, it may be appreciated that additional or alternative operations may be included, and/or that one or more operations may be omitted, depending on a desired configuration of the various embodiments.

In the example of FIG. 2, interactions between at least one service provider and at least one service consumer may be monitored during a time period (202). For example, the interaction monitor 116 of the evidence monitor 108 may monitor the interactions between the service provider 104 and the various consumers 106. For example, as described, the various interactions may be monitored through the exchange of messages or other transmissions between the evidence monitor 108 and the service provider 104 and/or the various consumers 106, and/or may occur by way of direct access on the part of the evidence monitor 108 to corresponding databases in which the interaction data is stored. As also described herein, parameters governing the manner in which such interactions are monitored may be provided using the GUI 115 and stored in the evidence repository 110, and, similarly, interaction data gathered by the evidence monitor 108 also may be stored in the evidence repository 110.

Further, it may be appreciated from the present description that the time period during which such interactions are monitored may have various characteristics associated therewith. For example, the time period may be closed-ended (e.g., may have a defined starting and/or ending point), or may be open-ended (e.g., ongoing). Further, it may be appreciated that the time period may be measured or otherwise characterized in units of time and/or in other desired manners. For example, a period of time may be measured or defined with respect to a number of interactions which occur, and/or with respect to some external event or circumstance (e.g., a period of time during which a particular product is available for sale).

A reputation score of the at least one service provider may be increased during the time period in accordance with a growth rate, as the interactions occur during the time period (204). For example, in conjunction with an initialization of a reputation score of the service provider 104 in conjunction with a corresponding time and/or event, the reputation engine 112 may begin to increase the reputation score over time, according to a corresponding growth rate, which, as described herein, may be received by way of the GUI 115 and stored/accessed using the reputation repository 114.

For example, as described and illustrated below, (e.g., with respect to FIGS. 5A-5D) the corresponding growth rate may dictate a relatively rapid initial growth of the reputation score following an initialization thereof and during an initial time period, followed by a slower approach to a maximum value for the reputation score. However, notwithstanding these or other growth characteristics associated with a corresponding growth rate, it may be appreciated from the present description that an actual growth of the reputation score of the service provider 104 may be affected by various factors. In particular, receipt of negative feedback may cause a corresponding decrease in the reputation score so that the reputation score may thereafter resume its growth over time, according to the original growth rate and/or additional or alternative growth rates.

Specifically, for example, negative feedback may be received from the at least one service consumer regarding a corresponding interaction of the interactions (206). For example, the evidence monitor 108 may include the feedback handler 118 which may be configured to receive various types of negative feedback from the various consumers 106 regarding one or more interactions with the service provider 104.

Techniques for receipt of such negative feedback are generally well known, and it may be appreciated that many such techniques, or combinations thereof, may be utilized by the feedback handler 118 in receiving negative feedback from the consumers 106. For example, consumers may be provided with an opportunity to provide feedback in conjunction with a purchase or delivery of goods for sale, and/or at a later time (e.g., such as when the consumer has had an opportunity to utilize a purchased product for a period of time). Further, the negative feedback may be received in many forms. For example, negative feedback can be as simple as a binary positive/negative indication on the part of the consumer, or even a single choice to provide negative feedback or not (e.g., the consumer may simply be provided with an opportunity to select a statement or other indication that the consumer was unhappy with a corresponding interaction).

Of course, many more elaborate techniques also may be used. For example, the consumer 106 may be provided with an ability to provide a relative degree of negative feedback, and/or may be permitted to provide accompanying text providing additional description of the consumer's negative personal experience. Still further, in some example embodiments, the feedback handler 118 may be configured to interact with the interaction monitor 116 in order to correlate negative feedback with specific, individual interactions.

However, in other example embodiments, a corresponding interaction need not be specified individually or uniquely. Instead, consumers 106 may simply be provided with an ability to provide negative feedback regarding multiple interactions with the service provider 104, and/or a general level of satisfaction associated with the service provider 104 by the consumer 106 (e.g., regarding a customer service interaction with the service provider 104 which need not itself be associated with a specific purchase of goods or services that may actually have been consummated).

The reputation score of the at least one service provider may be decreased in response to the negative feedback and in accordance with a negative feedback response characteristic (208). For example, the reputation engine 112 may be configured to receive information regarding the received negative feedback from the feedback handler 118, and may consult the reputation repository 114 to determine an appropriate, corresponding negative feedback characteristic to be used to determine a manner and/or extent to which the reputation score should be decreased.

For example, as described, in some example embodiments the negative feedback response characteristics may be stored in the reputation repository 114 after being received from an administrator or other user of the reputation engine system, e.g., by way of the GUI 115. Additionally, or alternatively, as also described, the reputation engine 112 may be configured to determine the negative feedback response characteristic automatically, e.g., based on the service provider 104, the consumers 106, or a nature of the interaction there between. In particular examples, as described and illustrated below with respect to FIGS. 5A-5D, relatively few instances of negative feedback (or even a single instance) may be sufficient to cause a significant and immediate decrease in the reputation score of the service provider 104.

An increase of the reputation score of the at least one service provider may be resumed in accordance with a redemption rate (210). For example, the reputation engine 112, after modifying the reputation score of the service provider 104 in response to the receipt of the negative feedback and in accordance with the negative feedback characteristic, may cause the reputation score to again grow larger over time during the time period.

As described herein, such resumption of growth may occur in accordance with a redemption growth rate, which may be the same or different as the original growth rate utilized immediately after initialization of the reputation score. In some example embodiments, the redemption growth rate may be set in a static manner, and utilized in the same way in response to each incident of receipt of negative feedback.

In other examples, however, different redemption growth rates may be utilized in response to multiple instances of negative feedback and/or in response to multiple types of negative feedback (e.g., dependent upon a type or extent of negative feedback that is received). For example, a first redemption growth rate may be utilized after a first receipt of negative feedback, while a second redemption growth rate may be used after a second receipt of negative feedback.

In other examples, after receipt of negative feedback, the reputation engine 112 may characterize the negative feedback, and select an appropriate redemption rate accordingly. For example, if the negative feedback is received in accordance with a scale of severity of negative feedback, then the reputation engine 112 may select a redemption rate based on a relative level of the negative feedback along the scale. Thus, various other factors which may be associated with the negative feedback, such as, e.g., a reputation of the consumer providing the negative feedback, an extent to which negative feedback is common in the industry of the service provider, or various other factors, may be considered by the reputation engine 112 with respect to whether and how to select a redemption growth rate to be used in response to a current incident of negative feedback having been received.

Thus, it may be appreciated that the features and techniques of FIGS. 1 and 2, as described above, assist the consumers 106 in assessing a trustworthiness of the service provider 104, even when a particular consumer has never transacted with the service provider 104. As described, the reputation management system 102 utilizes a trust model for assessing a reputation and trustworthiness of the service provider 104, using a minimal amount of resources, both in terms of a number of feedback incidents required, as well as in terms of required computation and memory resources.

The reputation management system 102 proceeds on an assumption, supported by empirical observations, that a positive bias exists in conventional feedback systems, and in the tendencies (on average), of the consumers 106. Therefore, as described above, such a positive bias may be represented by, and replaced with, a positive drift term, so that, as just described, the reputation score of the service provider 104 may generally increase over time in accordance with a corresponding growth rate, and without requiring consideration of whether and how actual incidence of positive feedback are received. Further, as described in detail below with respect to the examples of FIGS. 3-5D, the reputation engine 112 may be configured to calculate the reputation score of the service provider 104 using a single algebraic equation, thereby minimizing a time required to update the reputation score, and, again, enhancing a scalability of the reputation management system 102, and minimizing required computational resources for the implementation thereof.

Thus, it may be appreciated that the reputation management system 102 and associated trust model and related techniques, as described above with respect to FIGS. 1-2, may be implemented in a wide variety of settings and contexts. For purposes of providing a more specific example, FIG. 3 illustrates a block diagram of an example implementation of the reputation management system 102 of FIG. 1 in the context of a scenario related to the internet of services.

In this regard, the internet of services is known to be a commonly used name for open service markets using internet as a medium, in which a service broker 302 brings together various service providers 304 with corresponding service consumers 306. More specifically, in the example, the service providers 304 may offer their services via the service broker 302, serving as a central site or location for the obtaining of desired services by the various service consumers 306.

Thus, for example, the service consumers 306 may contact the service broker 302 to discover needed services, based on functional and non-functional criteria associated therewith. For example, the service consumers 306 may search for, or filter, available services based on criteria such as pricing, availability, quality of service (QoS) assurances, or relative levels of reputation scores. Thus, the service broker 302 may act as an intermediary in a discovery phase in which the service consumers 306 discover appropriate or desired service providers 304, and may also play a role in delivery of any selected services to requesting service consumers 306. Although various related functionalities of service brokers are known, such as, for example, aggregation of services, monitoring of services that are delivered, and various other functions, such functions are not described here in detail, except as may be necessary or helpful in understanding the various techniques described herein for determining and providing reputation scores associated with the service providers 304.

As may be appreciated, trust between the various entities 302-306 plays a central role in the successful implementation of the service broker 302 and the selection and delivery of services from the service providers 304 to the service consumers 306. For example, the service consumers 306 and/or the service broker 302 may wish to determine an appropriate level of trust to be associated with the given service provider of the service providers 304. However, as described, in open and evolving marketplaces which may be implemented using the structure of FIG. 3, thousands of different services and associated service providers may be available, so that, as described, conventional trust models and related techniques may be insufficient to provide the service broker 302 and/or the service consumers 306 with accurate trust assessment information, in a fast and efficient manner.

Thus, the features and functions described above with respect to FIGS. 1-2 may be implemented in the context of the service broker 302, in order to provide the various advantages described herein. For example, as shown, the service broker 302 may include a service registration and management component 308, which serves as the central registry at which the service providers 304 may advertise or otherwise make available the information that their various, corresponding services are available (e.g., including, descriptions of services, pricing information, and various other information which may be useful to potential consumers wishing to evaluate the services, including, as described in detail below, one or more relevant reputation scores associated with an individual service and/or a providing service provider). As shown, the service consumers 306 may consult the central service registration and management component 308, in order to search for, select, or otherwise identify or determine one or more services for the evaluation and potential purchase thereof.

In this context, an instance 310 of the reputation management system 102 of FIG. 1 may be implemented by the service broker 302 as being in communication with the central registration and management component 308. Then, as may be appreciated, the reputation management system 310 of FIG. 3 may be configured to include the same, additional, or alternative components as the reputation management system 102 of FIG. 1.

In particular, as shown, an evidence monitor 312 may be implemented which is configured to receive events related to interactions between the service providers 304 and the service consumers 306, including, e.g., actual purchases, customer service interactions, and any other interactions which may occur during the normal course of communications between a consumer and service provider during the providing of a relevant service. Of course, the evidence monitor 312 also may receive feedback from the service consumers 306, to be used during subsequent calculations of reputation scores associated with the various service providers 304. In particular, in this regard, a reputation engine 314 is illustrated which may be configured to compute reputation scores of the service providers 304, based on corresponding evidence received from the evidence monitor 312, and using a corresponding reputation algorithm (and associated growth rate and other relevant parameters).

Storage 316 represents memory and related hardware/software used to store data required for successful operation of the evidence monitor 312 and the reputation engine 314. That is, the storage 316 may be utilized to store information parameterizing or otherwise configuring the operations of the evidence monitor 312 and/or the reputation engine 314. In addition, the storage 316 may be utilized to store evidence collected by the evidence monitor 312, which may then be accessed by the reputation engine 314 to calculate corresponding reputation scores, which may themselves then be stored using the storage 316.

In particular, as shown, evidence repository 318, as just described, may store any and all information governing operations of the evidence monitor 312, as well as data collected by the evidence monitor 312. Similarly, the storage 316 may include a reputation repository 320, which states information governing operations of the reputation engine 314, as well as a computation history and service reputation history stored in association with each of the individual services and/or service providers 304.

Finally with regard to the storage 316, a configuration repository 322 is illustrated, which may be configured to store all services to be monitored, as well as relative configuration parameters. For example, it may be appreciated that the service providers 304 may include a large number of service providers, each of which may provide a potentially large number of services. Not all such services and/or service providers may be registered with the reputation management system 310 or computation of reputation scores associated therewith. Moreover, to the extent that individual services and/or service providers are registered with the reputation management system 310, it may be appreciated that a manner in which each such service/service provider is registered may vary, e.g., with regard to how reputation scores are collected and/or provided (e.g., published or otherwise made available).

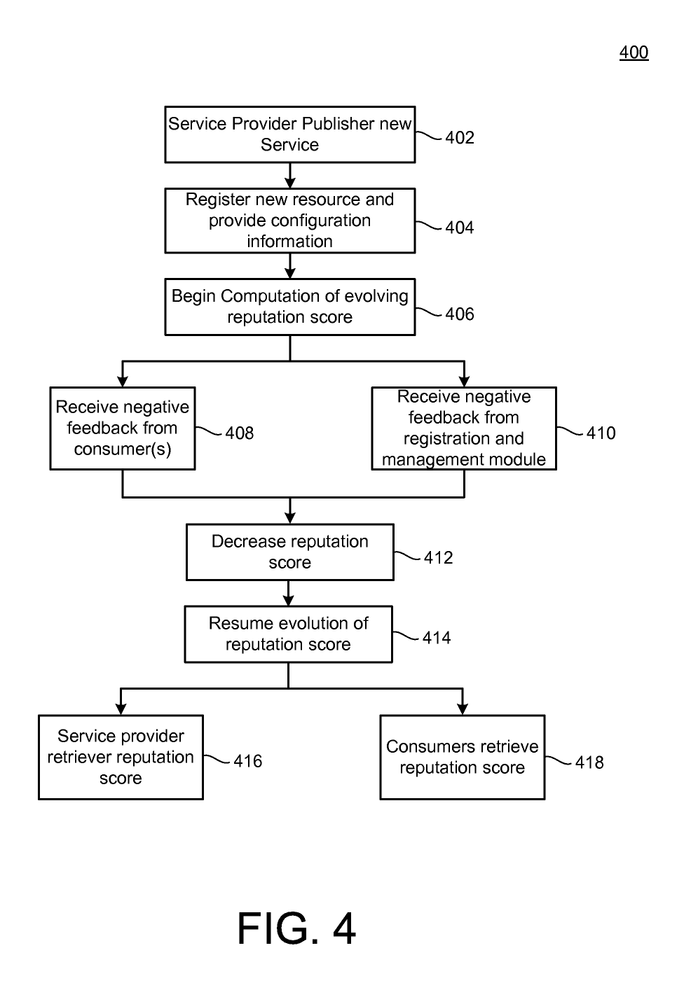

FIG. 4 is a flowchart illustrating detailed example operations of the system 300 of FIG. 3. In the example of FIG. 4, a new service may initially be published by one of the service providers 304 (402). For example, one of the service providers 304 may publish or otherwise provide a name and other relevant characteristics of a new service to the service registration and management module 308.

The service registration and management module 308 may then register this new service, and provide configuration information to the reputation engine (404). For example, such configuration information may include a service description for the new service, as well as various parameters characterizing operations of the service which may be relevant or useful to the reputation management system 310.

For example, as described above, such parameters may characterize transactions to be conducted between a service provider 304 and service consumers 306, a number of subscriptions to the service, a duration of one or more time periods during which a reputation score is to be calculated, various growth rates characterizing an evolution of a corresponding reputation score, and parameters characterizing an impact of negative feedback that is received. Further, as also may be appreciated from the above description of FIGS. 1 and 2, and from the above description of storage 316, the various repositories 318-322 may be used, as appropriate, to store corresponding parameters.

Then, the reputation engine 314 may be initialized, and may begin computations of the evolving reputation score (406). For example, a default or initial value for the reputation score may be set. Specifically, in the examples described below, a reputation score may be set with minimum and maximum values (e.g., minus 1, 1), so that a default initial value may be set as being neutral with respect to these minimum/maximum values (e.g., may be set to 0 in the examples just referenced). From this initial value, the reputation engine may begin evolving the corresponding reputation score, using an appropriate growth rate and associated growth algorithm.

As described, over time, negative feedback regarding the published service may be received. For example, as specifically described above, negative feedback may be received directly from one of the service consumers 306 (408), e.g., in response to a particular interaction between the service consumer in question and the relevant service.

In other examples, however, negative feedback may be received from the service registration and management module 308 (410). For example, the service registration and management module 308 may be configured to monitor brokered interactions between the service consumers 306 and the service providers 304. Then, the service registration and management module 308 may monitor a quality of service (QOS) and other delivery parameters associated with the providing of the service consumers 306. In this way, the service registration and management module 308 may detect a desired or unacceptable aspect of the providing of the service, and may transmit corresponding negative feedback to the reputation management system 310. Although not specifically illustrated in FIG. 4, it may be appreciated that, similarly, the evidence monitor 312 may be utilized to provide negative feedback to the reputation engine 314, based on monitoring functions implemented in conjunction with the various computations with the reputation score, as described herein.

In response to receipt of the negative feedback, the reputation engine 314 may decrease the corresponding reputation score (412). As may be appreciated from the above, a manner and extent to which the reputation score is decreased in response to received negative feedback may vary, based on the configuration information and other parameters designated by the corresponding service provider and/or service broker.

Subsequently, the reputation engine 314 may again begin to increase the reputation score over time, perhaps in accordance with a corresponding redemption rate (414). As described, such a redemption rate is generally analogous to the growth rate described earlier, but governs evolution of a reputation score in a period of time after a negative feedback has been received. As such, and as already described, the redemption rate may be smaller or larger than, or may otherwise vary in nature or extent with respect to, the original growth rate. As with the growth rate and related growth algorithms, such redemption rates may be provided by the corresponding service provider and/or service broker, may be stored in the reputation repository 320, and may otherwise be implemented in a desired or required manner.

As shown in FIG. 4, such calculations of the evolving reputation score may proceed, in conjunction with additionally-received negative feedback, if any, during the designated period of time (or associated number of transactions) that has been designated. During such time, the service provider may retrieve its relevant reputation score from the reputation engine 314, by way of the service broker 302 (416).

Further, as also described, various service consumers 306 may utilize the reputation score to locate and evaluate the service in question (418). For example, upon request from a service consumer, the service registration and management module 308 may utilize a required reputation score provided by the service consumer as a search parameter to be used in searching available services. In this way, for example, service consumers may be provided with services having a minimum reputation score.

FIG. 5A is a graph illustrating example evolutions of a reputation score in the absence of any negative feedback. More specifically, FIG. 5A illustrates three example reputation scores 502, 504, 506, each demonstrating the general properties of evolving from a starting, minimum reputation score (i.e., −1.0) to a maximum, saturation value, (e.g., 1.0).

As shown, and as may be appreciated from the above description, the example reputation scores 502, 504, 506 evolve as a function of a number of transactions which occur over a period of time, and in accordance with a designated growth rate. Specifically, in the example of FIG. 5A, the example reputation scores 502, 504, 506 are illustrated as corresponding to growth rates alpha=0.5, 1.0, 1.5, respectively.

Thus, FIG. 5A illustrates the general properties of a reputation score, as described above, of evolving over time from a minimum or other starting value, and in the absence of negative feedback, to a maximum or saturation value. In other words, the reputation scores 502-506 demonstrate a positive, but small, increase in the reputation score value as positive transactions are completed, or, at least, whenever there is no evidence of violation of service contract or other negative feedback. A rate of growth of each reputation score should generally decrease as the reputation score approaches its maximum/saturation value. However, as also shown, a relative rate of such a decrease, with respect to other reputation scores and/or with respect to a rate of increase which exists further from the maximum/saturation value, may vary, as demonstrated by the differing values of a in FIG. 5A. In this regard, equation 1 provides an example of a growth algorithm having these characteristics and useful in providing the reputation scores 502-506 of FIG. 5A, as described in more detail, below.

Tₙ₊₁=λrₙ(1−rₙ) Equation 1

In Equation 1, the index n refers to a number of the transactions in FIG. 5A. Meanwhile, the parameter λ represents a normalized version of the parameter alpha (α) in FIG. 5A. More specifically, in Equation 1, the reputation score may be very sensitive to variations in α, so that, in order to express the reputation score within the desired range [−1,1], it may be more convenient to express the growth rate by relating the parameter λ to the parameter α, according to λ=1+10^{-α}, αεR. As may be apparent from the below discussion, such a modification of the growth rate α may be particularly convenient in light of the relatively large effects negative feedback on the reputation score, and/or depending on a desired minimum and maximum values for the reputation score. In practice, λ sets the growth rate for low values of r, and also defines the (stable) maximum value of r. Equation 1 has a stable fixed point in r=(λ−1)/λ with λε[1, 2]

Meanwhile, an effect of receipt of negative feedback on the reputation score may be modeled according to equation 2:

Δrₙ₊₁=−βδ(n,nᵢ) Equation 2

As in Equation 1, the index n may represent a number of transactions (or, correspondingly, a duration of a relevant time period) corresponding to the receipt of the negative feedback. The δ function in Equation 2 takes the value of δ=1 if n=nᵢ (i.e., if the negative feedback is received with respect to the current transaction), and δ=0 if n does not equal nᵢ.

Further, β is a parameter that sets a magnitude of impact of the negative feedback on the reputation score. In practice, it may be desirable to set β to a relatively large value. For example, the β parameter may be chosen to be large enough to decrease the reputation score to a pre-defined value. For example, in example implementations, the reputation score may initially be set at a default, neutral value of 0 within the range [−1,1]. In such scenarios, the value of the β parameter may be selected to ensure that receipt of a single negative feedback reduces the overall reputation score to the default/starting value.

Setting of the β parameter in this manner may accurately reflect a level of impact of receipt of recent negative feedback, particularly in light of the overall bias of the reputation score to evolve in a positive direction. Moreover, such parameterization of the β parameter may serve as a defense against “exploitation of good reputation” attacks, in which a server with a currently-high reputation score may intentionally behave in a malicious manner, on the assumption that a resulting decrease in the reputation score would not have a practical effect.

In order to model the overall temporal evolution of a reputation score, Equations 1 and 2 may be combined, to thereby form Equation 3:

$${r}_{n + 1} = λ ( {r}_{n} + 1 ) ( 1 - \frac{( λ - 1 ) ( {r}_{n} + 1 )}{2 λ} ) - β δ ( n , {n}_{i} ) - 1 \qquad Equation 3$$

In Equation 3, in example embodiments, the parameter a may take values, for example, between 0 and 2, where larger values of α correspond to relatively faster increases in the reputation score. Similarly, β may be set within the range of 0 and 2. By setting the value of β=1, the above-referenced effect may be obtained in which a single essence of negative feedback decreases overall reputation score below a presumed starting value of 0. Moreover, when setting the starting value at neutral (0), the trust model is extremely sensitive to the first positive (as modeled by the bias) or negative behaviors (negative feedbacks), corresponding to the maximum of the slope of FIG. 5B.

Equations 4-8 provide additional detail regarding the derivation of Equation 3 from Equations 1 and 2. Specifically, combining Equations 1 and 2 yields Equation 4:

rₙ₊₁=λrₙ(1−rₙ)−βδ(n,nᵢ) Equation 4

In the absence of negative feedback, Equation 4 has a single stable fixed point at r=R_{FP}≡(λ−1)/λ, with λε[1, 2], so for any initial value r₀ε(0,1) it converges monotonically to R_{FP}. In other words, for any initial condition r₀ε(0, R_{FP}), r takes values in the interval (0, R_{FP}].

Thus, for the general case in which the reputation score \tilde{r} takes values in the bound interval Rε[Rₘᵢₙ, Rₘₐₓ], the following change of variables may be observed:

$$\tilde{r} = \frac{r}{{R}_{FP}} ( {R}_{ma x} - {R}_{m i n} ) + {R}_{m i n} \qquad Equation 5$$

so that Equation 4 may be written as:

$${\tilde{r}}_{n + 1} = λ ( {\tilde{r}}_{n} - {R}_{m i n} ) ( 1 - {R}_{FP} \frac{{\tilde{r}}_{n} - {R}_{m i n}}{{R}_{ma x} - {R}_{m i n}} ) - \frac{{R}_{ma x} - {R}_{m i n}}{{R}_{FP}} β δ ( n , {n}_{i} ) + {R}_{m i n} \qquad Equation 6$$

which has one stable fixed point at r=Rₘₐₓ and an unstable fixed point at r=Rₘᵢₙ. Then, by introducing \tilde{β}≡(Rₘₐₓ−βRₘᵢₙ)/R_{FP}, Equation 6 may be written as in Equation 7:

$${\tilde{r}}_{n + 1} = λ ( {\tilde{r}}_{n} - {R}_{m i n} ) ( 1 - {R}_{FP} \frac{{\tilde{r}}_{n} - {R}_{m i n}}{{R}_{ma x} - {R}_{m i n}} ) - \frac{{R}_{ma x} - {R}_{m i n}}{2} \tilde{β} δ ( n , {n}_{i} ) + {R}_{m i n} \qquad Equation 7$$

In the more specific examples given above, Rₘᵢₙ and Rₘₐₓ are set to (−1, 1), so that Equation 7 may be written as:

$${\tilde{r}}_{n + 1} = λ ( {\tilde{r}}_{n} + 1 ) ( 1 - {R}_{FP} \frac{{\tilde{r}}_{n} + 1}{2} ) - \tilde{β} δ ( n , {n}_{i} ) - 1 \qquad Equation 8$$

Then, it may be observed that Equation 8 yields the specific example of Equation 3 by explicitly adding the relationship that R_{FP}≡(λ−1)/λ.

As may be observed, Equation 3 may be computed quickly and easily, with minimal requirements of computational power and memory, thereby enabling a high degree of scalability, and/or implementation on relatively low powered devices. More specifically, equation 3 is a first order finite difference equation, since only the value of r₍ₙ₋₁₎ has to be stored in order to compute rₙ, thereby minimizing memory consumption. Further, Equation 3 is merely a second degree polynomial equation, which is easily and quickly computed by any standard computing device.

FIGS. 5B-5D illustrate graphs of evolving reputation scores in three different scenarios. Specifically, FIG. 5B illustrates an example scenario related to a relatively well-behaved service, FIG. 5C illustrates an example scenario related to a service which behaves negatively on an infrequent basis, and FIG. 5 D illustrates an example scenario in which a service regularly behaves in a negative manner.

Thus, with respect to FIG. 5B, as just referenced, an example service is considered which is understood to provide at least an expected quality of service most of the time, with rare exceptions. Thus, as shown, the reputation score may evolve to reach the value that is approximately equal to the maximum or saturation value at point 510, at which time negative feedback may be received (e.g., due to a downgrading of the quality of service). At this point, the reputation score reduces to below the neutral value of 0 at point 512, and then begins to recover its positive reputation. Upon reaching the maximum/saturation value again at point 514, additional negative feedback may be received, resulting in reduction of the reputation score by below the default/starting value at point 516. Thereafter, the reputation score may again evolve over time to reach the maximum/saturation value.

FIG. 5C illustrates a variation of a scenario in FIG. 5A, in which, for example, a service which collects personal identification information during a registration phase is required to handle such persona information according to a privacy policy (e.g., which may be agreed to with the service consumer during a registration process). In this context, the service consumer has very limited knowledge of what the service provider does with the personal information, and a number of transactions may not be related to possible infringement of the privacy policy, whereas the service consumer is more interested in being assured that the personal information is handled correctly over time. Therefore, in the example of FIG. 5C, the reputation score is explicitly calculated with respect to time, and, due to the above-referenced uncertainty, the positive bias governing evolution of the reputation score in the example of FIG. 5C may be set to a relatively low value. In such scenarios, once the reputation score is affected, the reputation score will take a relatively long time to recover.

Specifically, in the example of FIG. 5C, negative feedback may be received from a consumer at point 518, such as may occur when the service consumer receives a spam message on an email address provided during registration. Subsequently, the reputation score may be reduced to the value shown at point 520, whereupon the reputation score may begin to resume its evolution back toward the maximum/saturation value.

With respect to FIG. 5D, an example is illustrated of an evolution of a reputation score of a service which consistently behaves in a negative manner (e.g., a service which is known to send large quantities of spam emails). In the example, such a service may initially illustrate apparent good behavior (or, the consumer may not be able to quickly detect the existence of negative behavior), so that the reputation score may reach the maximum/saturation point at point 522. At point 522, negative feedback may be received, and the reputation score may begin to increase until negative feedback is again received at point 524. This pattern then repeats at points 526 and point 528, so that, as shown, the reputation score, over time, may approach a minimum possible value. As may be appreciated from Equation 3, the most significant increases or decreases in the reputation score may occur during an initial change of the reputation score from a starting/evolved value and/or from a value of the reputation score after receipt of negative feedback. Since, in the example, negative feedback is received soon after receipt of a previous negative feedback, the reputation score is likely to stay near the minimum value.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a non-transitory computer readable storage medium and executable by at least one processor, the system comprising:
an evidence monitor configured to cause the at least one processor to monitor interactions between at least one service provider and at least one service consumer during a time period, and further configured to cause the at least one processor to receive negative feedback from the at least one service consumer regarding a corresponding interaction of the interactions; and
a reputation engine configured to cause the at least one processor to increase a reputation score of the at least one service provider during the time period in accordance with a growth rate, as the interactions occur during the time period, and further configured to cause the at least one processor to decrease the reputation score of the at least one service provider in response to the negative feedback and in accordance with a negative feedback response characteristic.

2. The system of claim 1, wherein the reputation engine is configured to resume, after the receiving of the negative feedback, an increase of the reputation score of the at least one service provider in accordance with a redemption rate.

3. The system of claim 2, wherein the redemption rate is different from the growth rate.

4. The system of claim 1, wherein the interactions include commercial transactions involving a purchase of a service provided by the service provider.

5. The system of claim 1, wherein the evidence monitor is configured to monitor the interactions and to calculate negative feedback based thereon and provide the calculated negative feedback to the reputation engine, and wherein the reputation engine is configured to decrease the reputation engine based on the calculated negative feedback.

6. The system of claim 1, wherein the time period is defined in terms of a quantity of the interactions.

7. The system of claim 1, wherein the reputation engine is configured to calculate the reputation score within a range of minimum and maximum values, including automatically increasing the reputation score over time in the absence of negative feedback.

8. The system of claim 7, wherein the negative response feedback characteristic causes the decrease of the reputation score to be large relative to the growth rate and the range of minimum and maximum values.

9. The system of claim 1, wherein the reputation engine is configured to increase the reputation score based on the equation:
$${r}_{n + 1} = λ ( {r}_{n} + 1 ) ( 1 - \frac{( λ - 1 ) ( {r}_{n} + 1 )}{2 λ} ) - β δ ( n , {n}_{i} ) - 1$$
in which r represents the reputation score, n is an index representing a number of the interactions, nᵢ represents a current interaction, λ represents the growth rate, β characterizes the negative response feedback characteristic including an extent of impact of the negative feedback, and δ takes the value of δ=1 if n=nᵢ, and δ=0 if n does not equal nᵢ.

10. The system of claim 1, wherein the reputation engine is configured to provide the reputation score to the service provider and/or the at least one consumer, in response to a request therefrom.

11. A computer-implemented method for causing at least one processor to execute instructions recorded on a computer-readable storage medium, the method comprising:
monitoring interactions between at least one service provider and at least one service consumer during a time period;
increasing a reputation score of the at least one service provider during the time period in accordance with a growth rate, as the interactions occur during the time period;
receiving negative feedback from the at least one service consumer regarding a corresponding interaction of the interactions; and
decreasing the reputation score of the at least one service provider in response to the negative feedback and in accordance with a negative feedback response characteristic.

12. The method of claim 11, comprising resuming, after the receiving of the negative feedback, an increase of the reputation score of the at least one service provider in accordance with a redemption rate.

13. The method of claim 11, wherein increasing the reputation score comprises calculating the reputation score within a range of minimum and maximum values, including automatically increasing the reputation score over time in the absence of negative feedback.

14. A computer program product, the computer program product being tangibly embodied on a non-transitory computer-readable medium and comprising instructions that, when executed, are configured to cause at least one processor to:
monitor interactions between at least one service provider and at least one service consumer during a time period;
increase a reputation score of the at least one service provider during the time period in accordance with a growth rate, as the interactions occur during the time period;
receive negative feedback from the at least one service consumer regarding a corresponding interaction of the interactions; and
decrease the reputation score of the at least one service provider in response to the negative feedback and in accordance with a negative feedback response characteristic.

15. The computer program product of claim 14, wherein the instructions, when executed, are further configured to resume, after the receiving of the negative feedback, an increase of the reputation score of the at least one service provider in accordance with a redemption rate.

16. The computer program product of claim 14, wherein the instructions, when executed, are further configured to calculate the reputation score within a range of minimum and maximum values, including automatically increasing the reputation score over time in the absence of negative feedback.

17. The computer program product of claim 16, wherein the negative response feedback characteristic causes the decrease of the reputation score to be large relative to the growth rate and the range of minimum and maximum values.

18. The computer program product of claim 14, wherein the interactions include commercial transactions involving a purchase of a service provided by the service provider.

19. The computer program product of claim 14, wherein the instructions, when executed, are further configured to increase the reputation score based on the equation:
$${r}_{n + 1} = λ ( {r}_{n} + 1 ) ( 1 - \frac{( λ - 1 ) ( {r}_{n} + 1 )}{2 λ} ) - β δ ( n , {n}_{i} ) - 1$$
in which r represents the reputation score, n is an index representing a number of the interactions, nᵢ represents a current interaction, λ represents the growth rate, β characterizes the negative response feedback characteristic including an extent of impact of the negative feedback, and δ takes the value of δ=1 if n=nᵢ, and δ=0 if n does not equal nᵢ.

20. The computer program product of claim 14, wherein the instructions, when executed, are further configured to provide the reputation score to the service provider and/or the at least one consumer, in response to a request therefrom.
